(19) United States
(12) Patent Application Publication
(10) Pub. No.: US 2017/0351215 A1
(43) Pub. Date: Dec. 7, 2017

(54) MOVEMENT FOR MECHANICAL TIMEPIECE

(71) Applicant: CITIZEN WATCH CO., LTD., Nishitokyo-shi, Tokyo (JP)

(72) Inventor: Tadahiro Fukuda, Tokorozawa-shi, Saitama (JP)

(21) Appl. No.: 15/541,263

(22) PCT Filed: Dec. 24, 2015
(86) PCT No.: PCT/JP2015/085960

§ 371 Date: Jun. 30, 2017

(30) Foreign Application Priority Data
Jan. 5, 2015 (JP) 2015-000127

(51) Int. Cl. G04B 1/22; G04B 1/16

(52) U.S. Cl. CPC G04B 1/22; G04B 1/165

(57) ABSTRACT

According to a movement of the present disclosure, the prevention of the transmission of torque to a governor when excessive torque is generated and the prevention of the wasteful consumption of energy when the excessive torque is not generated are achieved. The movement includes a main spring which generates torque, a balance wheel, a gear train mechanism for transmitting the torque generated by the main spring to the balance wheel, and a spring seat for moving a second wheel, for example, of the gear train mechanism in a direction to reduce the transmission efficiency of the torque between the wheels of the gear train mechanism when the torque generated by the main spring is higher than a predetermined torque (Tmax).

### TECHNICAL FIELD

This invention relates to a mechanical timepiece movement.

### BACKGROUND ART

A mechanical timepiece movement includes a power source, a gear train mechanism having a plurality of gears which engages with each other, and an escapement and a governor. The gear train mechanism transmits power generated by the power source to the governor via the escapement and moves with a period controlled by the governor. The power source is a mainspring disposed within a barrel, for example. The mainspring of a manual watch is wound up as a user turns a crown, which is connected to a winding stem, with his or her fingers. The mainspring of an automatic winding watch is wound up as a rotor rotates in accordance with the motion of the watch. Torque is generated as the mainspring is released and is used as a power for driving the gear train mechanism, the governor, and the escapement.

The mainspring is not supposed to be further wound up beyond a state that the mainspring is wound up to a predetermined amount of winding (a fully-wound-up state); however, the mainspring may be further wound up from the fully-wound-up state. In particular, with the automatic watch, the mainspring in the fully-wound-up state may easily further wound up since the rotor rotates as the watch moves. Also, even with the manual winding watch, the mainspring may be further wound up from the fully-wound-up state.

When the mainspring is further wound up beyond the fully-wound-up state, the torque generated as the mainspring is released becomes higher than the torque generated as the mainspring is released from the fully-wound-up state. Accordingly, the torque transmitted to the governor via the gear train mechanism becomes higher than the torque expected from the fully-wound-up state. As a result, the oscillation of the governor becomes larger than expected, which leads to the occurrence of overbanking (overswinging) to regulate the maximum oscillation angle and an error in the isochronisms of the governor.

It has been proposed to uniformly reduce the torque generated from the fully-wound-up state of the mainspring and accordingly reduce the torque generated as the mainspring is further wound up beyond the fully-wound-up state so as to restrain the excessive amplitude of the governor. Also, a constant torque mechanism using the Remontoire mechanism has been proposed to prevent the variation of torque generated by the mainspring (Patent Literature 1).

### CITATION LIST

### Patent Literature

Patent Literature 1: JP 2014-81334 A

### SUMMARY

### Technical Problem

However, uniformly reducing torque generated by the mainspring causes a problem which shortens the duration time of the governor from the fully-wound-up state. Further, in the art proposed in Patent Literature 1, energy generated by the mainspring is wastefully consumed since the constant torque mechanism consumes the energy (the torque generated by the mainspring) even when the excessive torque is not generated.

The present invention is made in view of the above problems. An object of the present invention is to provide a mechanical timepiece movement which prevents or restrains the transmission of torque to the governor when the excessive torque is generated by the power source and also avoids the wasteful consumption of energy when the excessive torque is not generated.

### Solution to Problem

The present invention is a mechanical timepiece movement including a power source which generates torque; a governor; a gear train mechanism that transmits the torque generated by the power source to the governor, the gear train mechanism including a plurality of gears engaging with each other; and a moving mechanism that moves at least one of the gears of the gear train mechanism in a direction to reduce the transmission efficiency of the torque between the gears of the gear train mechanism when the torque generated by the power source is higher than a predetermined torque.

### Advantageous Effects

According to the present invention, the mechanical timepiece movement can prevent or restrain the transmission of torque to the governor when the excessive torque is generated by the power source and can also avoid the wasteful consumption of energy when the excessive torque is not generated.

### BRIEF DESCRIPTION OF DRAWINGS

FIG. 1 is a top plan view of a movement of a mechanical portable timepiece (a wristwatch, for example) according to the first embodiment (Embodiment 1) of the present invention.

FIG. 2A is a perspective view of a spring seat (an example of a moving mechanism) which roratably supports a pivot of a second wheel and shows a spring in a non-compressed state.

FIG. 2B is a perspective view of the spring seat of FIG. 2A and shows the spring in a compressed state.

FIG. 3A is a cross-sectional view along a vertical surface depicted with a line I-I in FIG. 2A.

FIG. 3B is a cross-sectional view along a vertical surface depicted with a line I-I in FIG. 2A, which corresponds to the state of FIG. 2B.

FIG. 4 is a back view of a gear train mechanism seen from the back side of the gear train mechanism of FIG. 1.

FIG. 5 is a graph showing barrel torque corresponding to an elapsed time from a wound-up state to a released state of a mainspring, and values obtained by multiplying the torque transferred to a balance wheel, which corresponds to the barrel torque, by a reduction ratio.

FIG. 6 is a perspective view of a spring seat, which is another example of a moving mechanism, in a movement according to the second embodiment (Embodiment 2) of the present invention.

FIG. 7A is a perspective view of a spring seat, which is yet another example of a moving mechanism, in a movement according to the third embodiment (Embodiment 3) and shows the spring seat assembled and disposed in a main plate.

FIG. 7B is an exploded perspective view of the spring seat shown in FIG. 7A.

### DESCRIPTION OF EMBODIMENTS

The embodiments of a mechanical timepiece movement will be described with reference to the figures.

### First Embodiment

(Configuration of Movement)

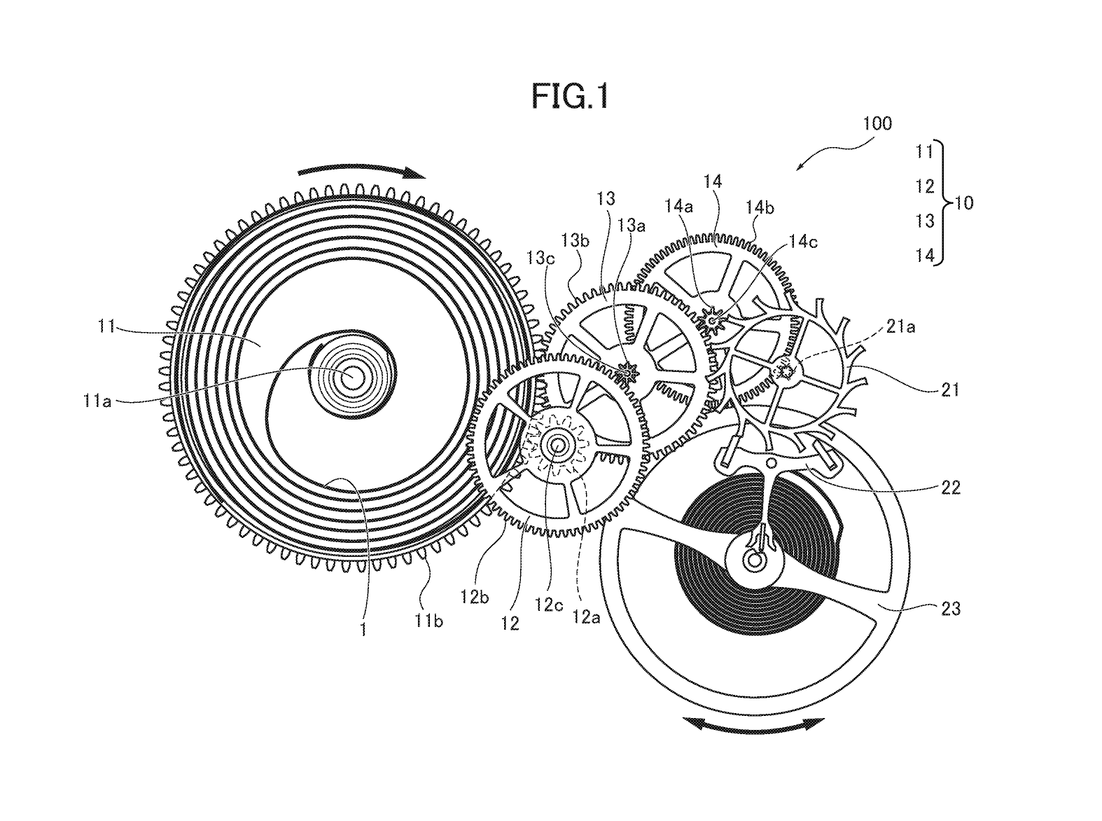

FIG. 1 is a schematic view illustrating a movement 100 of a mechanical portable watch (a wristwatch, for example) according to the first embodiment (Embodiment 1) of the present invention. The movement 100 shown in the figure includes a mainspring 1 as an example of a power source, a gear train mechanism 10, an escape wheel 21 and an anchor 22 (an escapement), and a balance wheel 23 (a governor). The mainspring 1 is disposed within a rotary barrel 11, which is a first wheel, in the gear train mechanism 10.

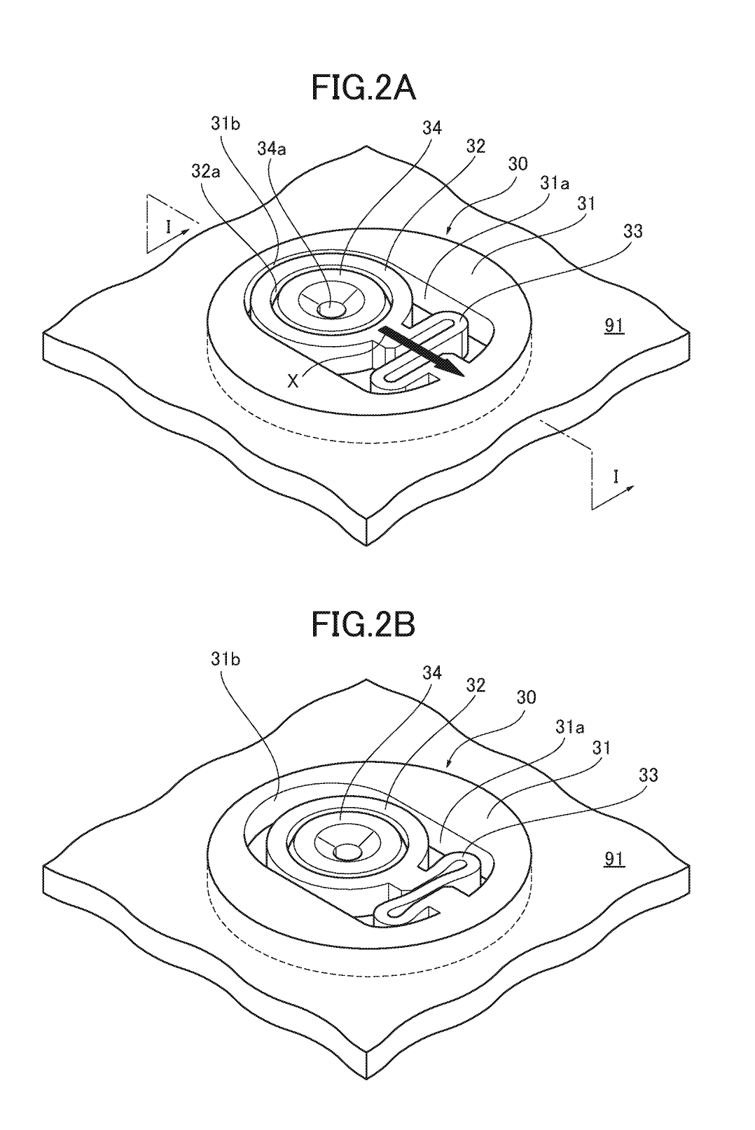

The inner end of the mainspring 1 is hooked to a barrel arbor 11a. Turning a crown (not shown) (in case of a manual watch) or rotating a rotor (in case of an automatic winding watch) rotates the barrel arbor 11a so that the mainspring 1 is wound around the barrel arbor 11a. Then, torque is generated as the mainspring 1 wound around the barrel arbor 11a is released (referred to barrel torque hereinafter) and the torque rotates the rotary barrel 11 about the barrel arbor 11a which is a rotation axis. The barrel arbor 11a is rotatably supported by a main plate 91 (see FIG. 2A, 2B which will be described hereinafter) and a barrel plate.

The gear train mechanism 10 includes the rotary barrel 11, a second wheel 12 (an example of a gear train to be moved), a third wheel 13 and a fourth wheel 14. As described above, the rotary barrel 11 includes the mainspring 1 disposed therewithin and rotates around the barrel arbor 11a. The rotary barrel 11 includes a gear 11b around the outer circumference of the barrel 11. The second wheel 12 is integrally formed with a pinion 12a, a gear 12b and a tenon or pivot 12c which is provided as an axis of the pinion 12a and the gear 12b. Similarly, the third wheel 13 is integrally formed with a pinion 13a, a gear 13b and a tenon or pivot 13c which is provided as an axis of the pinion 13a and the gear 13b. The fourth wheel 14 is integrally formed with a pinion 14a, a gear 14b and a tenon or pivot 14c which is provided as an axis of the pinion 14a and the gear 14b.

Each pivot 12c, 13c, 14c of the second wheel 12, the third wheel 13, and the fourth wheel 14 is rotatably supported by the main plate 91 and a gear train bridge. Accordingly, the second wheel 12, the third wheel 13 and the fourth wheel 14 rotate about the pivot 12c, 13c, 14c, respectively. The pinion 12a of the second wheel 12 engages with the gear 11b of the rotary barrel 11 to receive the barrel torque generated in accordance with the rotation of the rotary barrel 11, which is a driving gear, and rotates about the pivot 12c which is a rotation axis. The pinion 13a of the third wheel 13 engages with the gear 12b of the second wheel 12 to receive the torque generated in accordance with the rotation of the second wheel 12, which is a driving gear, and to rotate about the pivot 13c which is a rotation axis. The pinion 14a of the fourth wheel 14 engages with the gear 13b of the third wheel 13 to receive the torque generated in accordance with the rotation of the third wheel 13, which is a driving gear, and to rotate about the pivot 14c which is a rotation axis.

The gear 14b of the fourth wheel engages with a pinion 21a of the escape wheel 21 to rotate the escape wheel 21. The escape wheel 21 and the anchor 22 constitute an escapement, and the balance wheel 23 constitutes a governor. The escape wheel 21, the anchor 22 and the balance wheel 23 interact with each other in a conventional manner to control the advancement and the speed of the gear train mechanism 10.

(Configuration of Spring Seat)

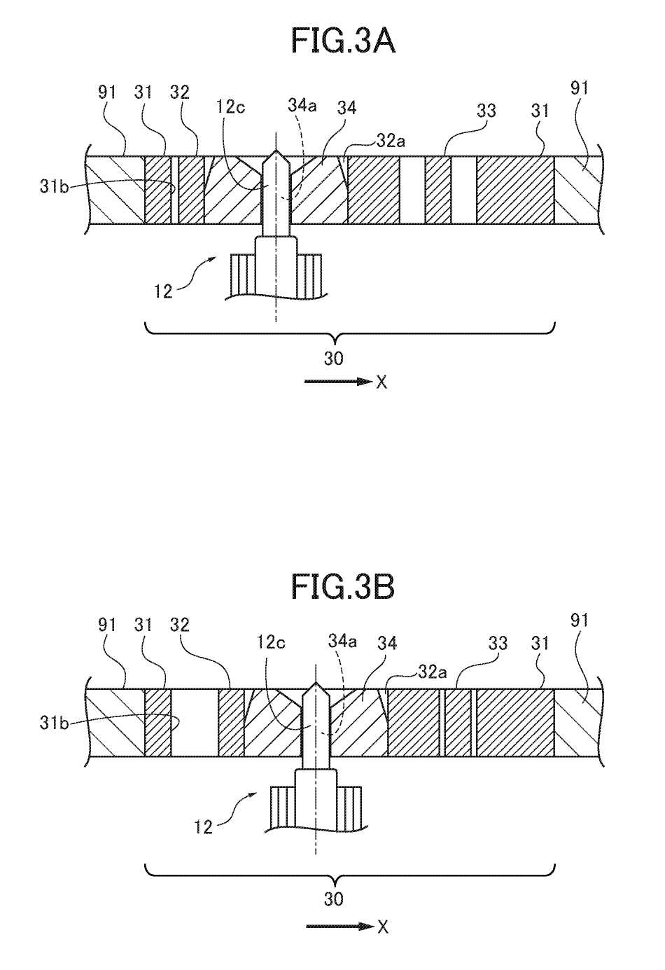

FIG. 2A is a perspective view of a spring-provided seat or spring seat 30 (an example of the moving mechanism) which rotatably supports the pivot 12c of the second wheel 12 (see FIG. 1) and illustrates a spring 33 in a non-compressed state. FIG. 2B is a perspective view of the spring seat 30 shown in FIG. 2A and illustrates the spring 33 in a compressed state. FIG. 3A is a cross-sectional view along a vertical surface depicted with a line I-I in FIG. 2A. FIG. 3B is a cross-sectional view along a vertical surface depicted with a line I-I in FIG. 2A, which corresponds to the state of the spring member shown in FIG. 2B.

The pivot 12c of the second wheel 12 is supported by the spring seat 30 shown in FIGS. 2A, 2B, 3A and 3B. The spring seats 30 are provided in the main plate 91 disposed above the second wheel 12 and in the gear train bridge disposed below the second wheel 12, respectively. Note that FIGS. 2A, 2B, 3A and 3B show the spring seat provided in the main plate 91; however, the spring seat 30 provided in the gear train bridge is identical to the one shown in FIGS. 2A, 2B, 3A, 3B. The position of the main plate 91 may be replaced with that of the gear train bridge. The spring seat 30 includes a guide 31 (an example of a base member), a seat 32 and a spring 33 (an example of a biasing member).

The seat 32 has a circular shape in a plan view and includes a recess 32a formed inside the seat 32, which receives an end stone 34. The end stone 34 includes a bearing hole 34a for rotatably supporting the pivot 12c of the second wheel 12. The pivot 12c is supported by the hole 34a. The guide 31 has a circular shape in a plan view and includes an elongate hole 31a formed inside the guide 31 for receiving the seat 32. The elongate hole 31a is configured such as to allow the seat 32 to move in a longitudinal direction X. The outer circumference of the guide 31 is fitted into a hole formed in the main plate 91 and the guide 31 is fixed to the main plate 91.

The spring 33 has a substantially S-shaped contour in a plan view. The spring 33 is disposed within the elongate hole 31a such that one and the other ends of the S-shaped spring 33 are placed along the longitudinal direction X of the elongate hole 31a of the guide 31. The spring 33 is formed from a material which allows the S-shaped spring to elastically deform as a load beyond a predetermined value is applied between the one end and the other end of the S-shaped spring 33 in the longitudinal direction X. The one end and the other end of the S-shaped spring 33 is connected to the guide 31 and the other end is connected to the seat 32.

As shown in FIGS. 2A and 3A, the spring 33 biases the seat 32 and the end stone 34 toward an end 31b of the longitudinal direction X of the elongate hole 31a when the spring 33 is not elastically deformed. As shown in FIGS. 2B and 3B, on the other hand, the seat 32 and the end stone 34 move away from the end 31b of the longitudinal direction X of the elongate hole 31a when the load exceeding the predetermined value is applied between the one end and the other end of the S-shaped spring 33 in the longitudinal direction X and the S-shaped spring elastically deforms. Resultingly, the pivot 12c of the second wheel 12 moves from a position shown in FIG. 3A to a position shown in FIG. 3B along the longitudinal direction X. Note that the spring seat 30 in Embodiment 1 is integrally formed with the guide 31, the seat 32 and the spring 33.

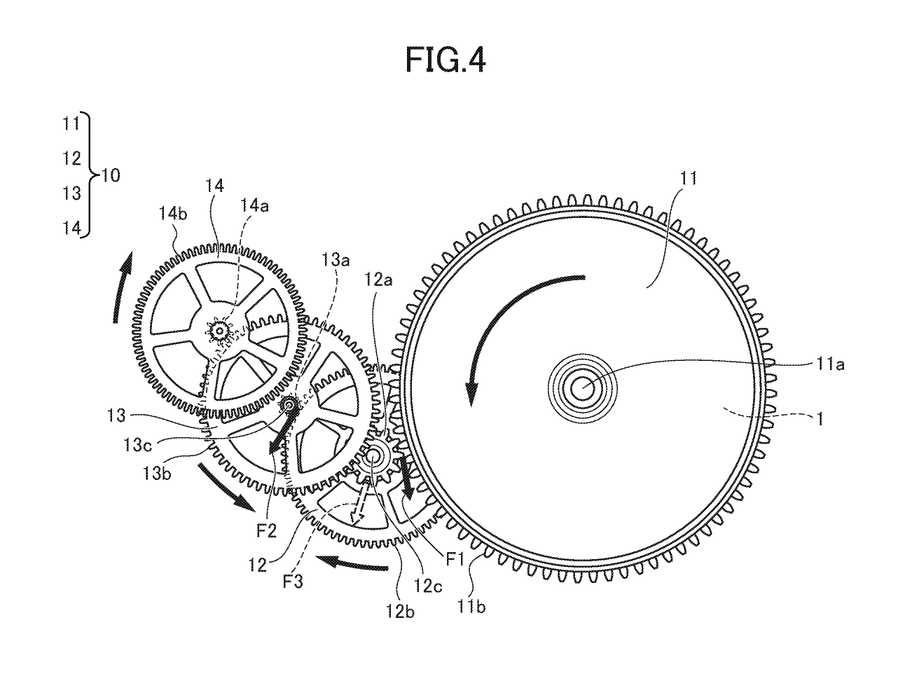

FIG. 4 is a back view of the gear train mechanism 10 shown in FIG. 1. The barrel torque is generated as the mainspring 1 disposed within the rotary barrel 11 is released. The barrel torque rotates the rotary barrel 11 in a direction of an arrow shown in FIG. 4 (in the counterclockwise direction). The gear 11b of the rotary barrel 11 transmits the torque to the pinion 12a of the second wheel 12. That is, the rotary barrel 11 corresponds to a driving gear as seen from the second wheel 12. In accordance with the torque of the rotary barrel 11, a load F1 acts on the second wheel 12 from the rotary barrel 11. On the average, the load faces a direction inclined at the friction angle relative to a tangential direction in common with the gear 11b and the pinion 12a, though the facing direction technically differs depending on the shapes of the teeth (teeth profiles) engaging with each other and the conditions of the engagement between the teeth.

Then, the torque transmitted to the second wheel 12 rotates the second wheel 12 in a direction of an arrow shown in FIG. 4 (in the clockwise direction). The gear 12b of the second wheel 12 transmits the torque to the pinion 13a of the third wheel 13. That is, the third wheel 13 corresponds to a driven gear as seen from the second wheel 12. In accordance with the torque of the second wheel 12, a load acts on the pinion 13a of the third wheel 13 from the gear 12b of the second wheel 12. On the average, the load faces a direction inclined at a friction angle relative to a tangential direction in common with the gear 12b and the pinion 13a, though the facing direction technically differs depending on the shapes of the teeth engaging with each other and the conditions of the engagement between the teeth. In accordance with an action and reaction relationship, a reaction load F2 acts on the second wheel 12 from the third wheel 13. Similarly, on average, the reaction load F2 acting on the second wheel 12 from the third wheel 13 faces to a direction inclined at the friction angle relative to the tangential direction in common with the gear 12b and the pinion 13a.

Accordingly, the second wheel 12 receives the load F1 from the rotary barrel 11 and the load F2 from the third wheel 13. The spring seat 30 shown in FIGS. 2A, 2B, 3A, 3B is positioned such that the longitudinal direction X of the elongate hole 31a coincides with the direction of a resultant force F3 obtained from the vector addition of the two loads F1, F2. Here, the spring seat 30 is positioned in a direction such that the load F3 acts on the second wheel 12, and the seat 32 and the end stone 34 supporting the pivot 12c compress the spring 33 in the longitudinal direction X.

Note that the direction of the resultant force F3 is a direction in which the pivot 12c of the second wheel 12 moves away from the rotary barrel 11, which is the driving gear, and also moves away from the third wheel 13, which is the driven gear. Accordingly, the longitudinal direction X of the elongate hole 31a is a direction in which the pivot 12c of the second wheel 12 moves away from the rotary barrel 11 and also moves away from the third wheel 13.

(Operation of Movement)

In the movement 100 configured as described above, turning a non-illustrated crown or rotating a non-illustrated rotor rotates the barrel arbor 11a so that the mainspring 1 is wound around the barrel arbor 11a. The barrel torque generated by the mainspring 1, which is wound around the barrel arbor 11a, is sequentially transmitted from the rotary barrel 11 to the second wheel 12, the third wheel 13, the fourth wheel 14, the escape wheel 21, the anchor 22 and then the balance wheel 23.

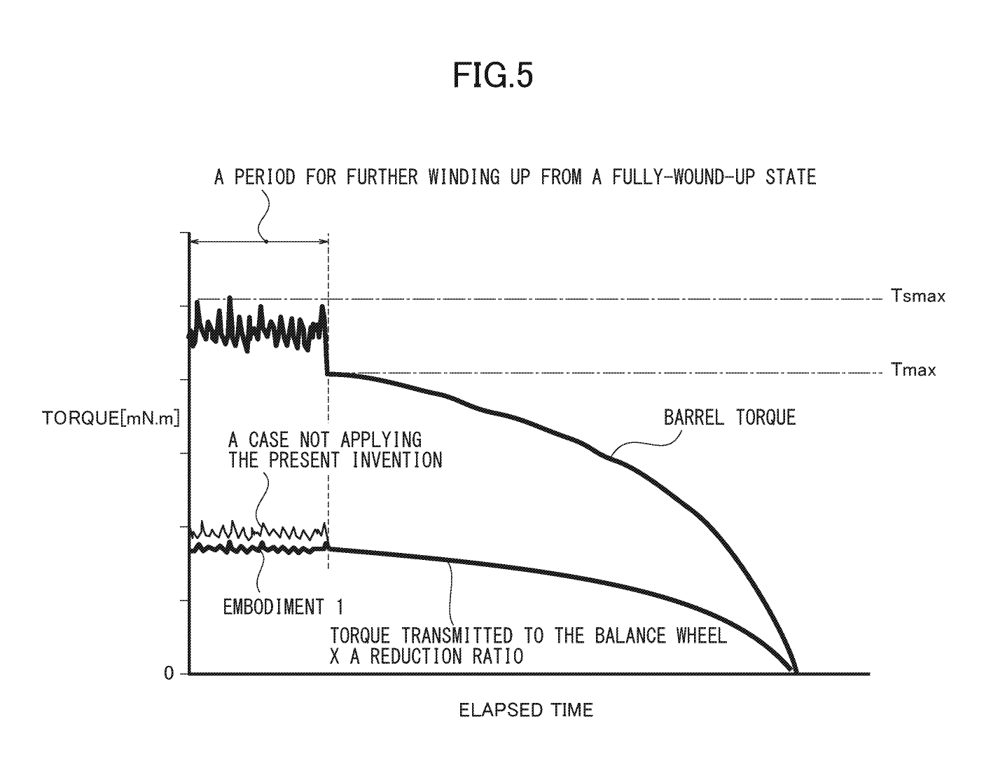

FIG. 5 is a graph showing the barrel torque with respect to an elapsed time from the wound-up state to the released state of the mainspring 1, and values obtained by multiplying the torque transferred to the balance wheel 23, which corresponds to the barrel torque, by a reduction ratio. As shown in FIG. 5, Tmax indicates the barrel torque in the state that the mainspring 1 (see FIG. 1) is wound up to the predetermined amount of winding (the fully-wound-up state). The longer the elapsed time for releasing the mainspring 1 from the fully-wound-up state becomes, the lower the barrel torque becomes. As the barrel torque falls below a minimum value required to drive the balance wheel 23, the gear train mechanism 10 does not move anymore and the movement of the watch stops.

The barrel torque Tmax corresponding to the fully-wound-up state is determined in advance. In accordance with the determined barrel torque Tmax, the specifications of the movement 100 such as oscillation angle of the balance wheel 23 are set. However, the mainspring 1 may be further wound up from the fully-wound-up state. During the further winding of the mainspring 1, the barrel torque reaches a torque Tsmax beyond the torque Tmax in the fully-wound-up state as shown in the left side of FIG. 5.

Frictions such as contact friction or viscous friction in the gear train mechanism 10, the escape wheel 21, and/or the anchor 22 consume energy from the barrel torque while the energy is transmitted to the balance wheel 23. For example, the gear train mechanism 10 consumes about 30% of the energy of the barrel torque, and the escape wheel 21 and the anchor 22 consume about 35% of the energy of the barrel torque. As a result, about 35% of the energy of the barrel torque is transmitted to the balance wheel 23.

The barrel torque reaches the torque Tsmax beyond the torque Tmax during the mainspring 1 is further wound up from the fully-wound-up state since the maximum value of the oscillation angle of the balance wheel 23 is set in accordance with the assumed barrel torque Tmax. In this case, with the conventional movement which differs from Embodiment 1 of the present invention, the value obtained by multiplying the torque transferred to the balance wheel 23 by a reduction ratio also becomes torque (35% of the barrel torque Tsmax) higher than the assumed torque (35% of the barrel torque Tmax) as shown with a thinner line in FIG. 5. Then, the balance wheel 23 oscillates at an oscillation angle beyond the assumed angle, resulting in the occurrence of so called overbanking.

With the movement 100 of Embodiment 1 of the present invention, on the other hand, the spring seat 30 moves the second wheel 12 in a direction which reduces the transmission efficiency of the torque in the gear train mechanism 10 when the barrel torque is higher than the predetermined torque Tmax. The spring seat 30 does not move the second wheel 12 when the barrel torque does not exceed the predetermined torque Tmax.

Specifically, with the resultant force F3 between the load F1 (see FIG. 4) from the barrel torque of the rotary barrel 11 and the load F2 from the third wheel 13, the second wheel 12 intends to move in the direction of the resultant force F3. Here, the pivot 12c of the second wheel 12 is supported by the end stone 34 and the end stone 34 is fixed to the seat 32. However, the resultant force F3 acting on the pivot 12c does not elastically deform the spring 33 when the barrel torque does not exceed the torque Tmax (see FIGS. 2A and 3A). Accordingly, the second wheel 12 is maintained in the state shown in FIGS. 2A and 3A when the barrel torque does not exceed the predetermined torque Tmax. In this state, about 30% of the energy of the barrel torque in the gear train mechanism 10 is consumed.

When the barrel torque exceeds the predetermined torque Tmax, on the other hand, the resultant force F3 acting on the pivot 12c of the second wheel 12 elastically deforms the spring 33 (see FIGS. 2B and 3B). The deformation of the spring 33 moves the second wheel 12 in the longitudinal direction X so as to reduce the efficiency of the engagement between the gear 11b of the rotary barrel 11 and the pinion 12a of the second wheel 12 and accordingly to reduce the transmission efficiency of the torque from the rotary barrel 11 to the second wheel 12. In addition, the movement of the second wheel 12 along the longitudinal direction X reduces the efficiency of the engagement between the gear 12b of the second wheel 12 and the pinion 13a of the third wheel 13 to reduce the transmission efficiency of the torque from the second wheel 12 to the third wheel 13.

As described above, reducing the transmission efficiency of the torque in the gear train mechanism 10 increases the energy consumption of the barrel torque to about 35%, for example. Accordingly, the movement 100 of Embodiment 1 can reduce the barrel torque transmitted to the escape wheel 21 from the gear train mechanism 10 compared to the conventional movement which does not move the second wheel 12. Therefore, about 30% of the energy of the barrel torque is transmitted to the balance wheel 23 since the escape wheel 21 and the anchor 22 still consume about 35% of the energy of the barrel torque.

As a result, as shown with a bold line in FIG. 5, the value obtained by multiplying the torque transmitted to the balance wheel 23 by the reduction ratio becomes a torque (30% of the barrel torque Tsmax) which is substantially the same as that of the assumed torque (35% of the barrel torque Tmax). Accordingly, the oscillation of the balance wheel 23 at an oscillation angle beyond the assumed angle is prevented or restrained and therefore the occurrence of so-called overbanking can be prevented or restrained.

According to the Embodiment 1 of the present invention, the movement 100 can prevent or restrain the transmission of the excessive barrel torque to the balance wheel 23 (the increase in the oscillation angle) even when the mainspring 1 generates the excessive barrel torque (the barrel torque exceeds the torque Tmax), and can also avoid wasteful energy consumption when the excessive barrel torque is not generated (the barrel torque does not exceed the torque Tmax).

Further, in the movement 100 of Embodiment 1, the spring seats 30 are provided such as to move, in the same direction, the end stones 34 (the end stone 34 of the spring seat fixed to the main plate 91 and the end stone 34 of the spring seat fixed to the gear train bridge) which support the pivot 12c of the second wheel 12 at the upper and the lower ends of the pivot, respectively. Hence, the upper and lower spring seats 30 move in the same direction as the direction in which the second wheel 12 is moved. Therefore, configuring the upper and lower spring seats 30 to move for the same distance with the consideration of the lateral pressure on the upper and lower pivots of the second wheel 12 can prevent the inclination of the second wheel 12 relative to the vertical direction when the second wheel 12 is moved.

Note that the mechanical timepiece movement according to the present invention is not limited to one which moves both of the upper and lower end stones supporting the pivot of the gear moved by the moving mechanism. Therefore, the moving mechanism such as the spring seat 30 may be disposed either at the upper side or the lower side of the pivot. The movement with the moving mechanism disposed either at the upper side or the lower side of the pivot can also reduce the efficiency of the engagement between the gears forming the train gear mechanism and accordingly reduce the transmitting efficiency of the barrel torque.

In the mechanical timepiece movement according to Embodiment 1, the spring 33 biases the end stone 34 with the elastic force (applies a load pressing the end stone) toward the end 31b closer to the rotary barrel 11 along the longitudinal direction X of the elongate hole 31a. As a load against the elastic force of the spring 33 acts on the end stone 34, the spring 33 moves the end stone 34 in a direction away from the rotary barrel 11 for a distance corresponding to the magnitude of the acting load. That is, the heavier the load acting on the end stone 34 becomes, the longer the distance from the end stone 34 to the rotary barrel 11 becomes.

Then, the longer the distance from the end stone 34 to the rotary barrel 11 becomes, the lower the transmitting efficiency of the barrel torque from the rotary barrel 11 to the second wheel 12 becomes. According to the mechanical timepiece movement 100 of the Embodiment 1, the degree of the restraint of the torque transmitted to the balance wheel 23 increases as the amount of the barrel torque exceeding the predetermined torque Tmax becomes greater so that the variation of the torque transmitted to the balance wheel 23 can be restrained. In addition, in the mechanical timepiece movement 100 according to Embodiment 1, the moving mechanism can be achieved with a simpler configuration since the movement 100 does not include an independent sensor for sensing the magnitude of the barrel torque or a controller for controlling the degree of the transmission to the balance wheel 23 in accordance with values sensed by the sensor.

In the mechanical timepiece movement 100 according to Embodiment 1, the spring 33 providing elastic force biases the end stone 34. However, the movement of the present invention is not limited to above movement in which the spring 33 biases the end stone. Therefore, the biasing member in the mechanical timepiece movement according to Embodiment 1 can be any member as long as it can provide a tension load or a compressing load on the end stone 34. For example, the present invention may adopt an elastic member for providing elastic force such as a coil spring, a leaf spring or a rubber, or a magnetic member (a magnet) for providing magnetic force such as attraction and repulsion. In the mechanical timepiece movement 100 according to Embodiment 1, the seat 32 supports the end stone 34. However, the seat 32 may be eliminated, and the end stone 34 may be directly biased by the spring 33.

In the mechanical timepiece movement 100 according to Embodiment 1, the spring seat 30 is formed with the elongate hole 31a, and is integrated as a unit with the guide 31 fixed to the main plate 91 and the gear train bridge, with the seat 32 disposed within the elongate hole 31a and including the end stone 34, and with the spring 33. Since the guide 31, the seat 32, and the spring 33 cannot be separated from each other, the spring seat 30 can be easily handled compared to a spring seat configured with the guide 31, the seat 32, and the spring 33, each of which is an independent element.

In addition, the moving mechanism (the spring seat 30) which moves the second wheel 12 may be mounted in the movement 100 only by fixing the guide 31 of the unitized spring seat 30 to the main plate 91 and the gear train bridge. Accordingly, in order to mount the moving mechanism to the main plate 91 and the gear train bridge, it is only required to open a hole for receiving the guide 31 on the main plate 91 and the gear train bridge, which makes the required work minimum. This prevents the configuration of the main plate 91 and the gear train bridge from being complicated compared to one configured by opening the elongate hole 31a on the main plate 91 and the gear train bridge, and then by placing the seat 32 and the spring 33 within the elongate holes.

Note that the mechanical timepiece movement of the present invention does not intend to eliminate the above described moving mechanism configured by opening the elongate hole 31a on the main plate 91 and the gear train bridge, and by placing the seat 32 and the spring 33 within the elongate hole. It is also possible to adopt the moving mechanism configured by opening the elongate hole 31a on the main plate 91 and the gear train bridge, and placing the seat 32 and the spring 33 within longitudinal the hole.

In the mechanical timepiece movement 100 according to Embodiment 1, the spring seat 30 moves the second wheel 12. However, the movement of the present invention is not limited to one in which the moving mechanism moves the second wheel 12. Accordingly, the spring seat 30 may move the rotary barrel 11, the third wheel 13, or the fourth wheel 14. Further, if the gear train mechanism 10 includes other gears aligned with the balance wheel 23 in addition to the rotary barrel 11, the second wheel 12, the third wheel 13, and the fourth wheel 14, the spring seat 30 may be configured to move such other gears aligned with the balance wheel 23.

Note that the axes of the above gears of the gear train mechanism 10 moved by the spring seat 30 is preferably not common with the axes of hands such as a hour hand, a minute hand and a second hand. The gears having the common axes with these hands discomforts a user who looks at the moving hands since the hands are also moved as the gears are moved by the spring seat 30. Further, the spring seat 30 is not limited to one which moves only one of the gears forming the gear train mechanism 10. The spring seat 30 may move more than one gear of the gear train mechanism 10.

In the movement 100 of this embodiment, the longitudinal direction X of the elongate hole 31a of the spring seat 30 corresponds to the directions in which the pivot 12c of the second wheel 12 moves away from the rotary barrel 11, which is a driving gear, and also moves away from the third wheel 13, which is a driven gear. This reduces the efficiency of the torque transmission between the second wheel 12 and the rotary barrel 11 and between the second wheel 12 and the third wheel 13. Accordingly, it can increase the reduction of the torque transmission efficiency relative to the distance for which the end stone 34 moves. In addition, a space required to move the end stone 34 can also be reduced.

Note that in the mechanical timepiece movement of the present invention, the longitudinal direction X of the elongate hole 31a may correspond to a direction in which the moving mechanism moves the gear away from at least one of a driven gear or a driving gear. Resultingly, the torque transmission efficiency between the gears of the gear train mechanism is reduced.

### Second Embodiment

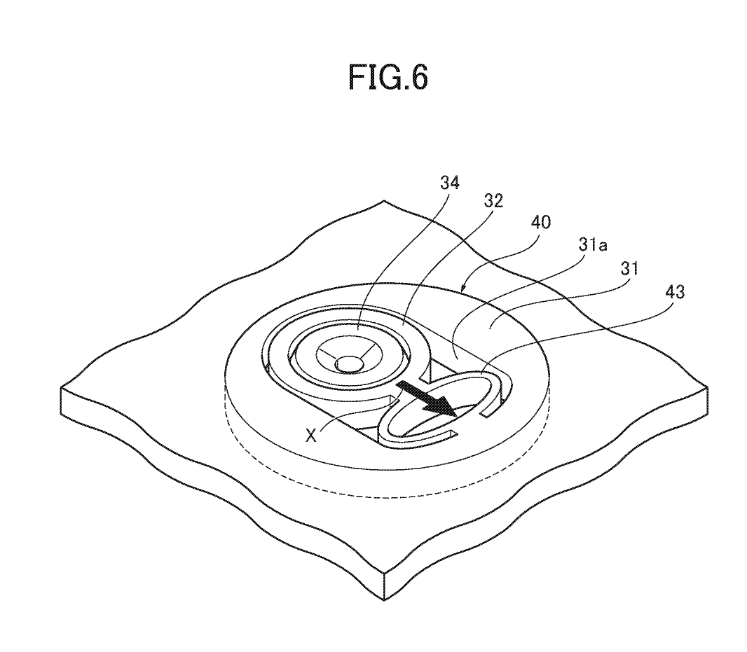

FIG. 6 is a perspective view of a spring-provided seat or spring seat 40 which is another example of the moving mechanism in the mechanical timepiece movement according to the second embodiment (Embodiment 2) of the present invention. The spring seat 40 has the same configuration as the spring seat 30 shown in FIGS. 2A and 2B with the exception of a spring 43 which is replaced with the spring 33. The spring 33 in the spring seat 30 has a S-shaped contour in a plan view but the spring 43 of the spring seat 40, on the other hand, has an ellipse annular contour in a plan view. The spring 43 is configured such that the shorter diameter direction of the ellipse annular contour extends along the longitudinal direction X of the elongate hole 31a.

In the spring seat 40 of Embodiment 2 as configured above, a state in which the spring 43 biases the seat 32 is maintained and remains as shown in FIG. 6 unless the barrel torque exceeds the predetermined torque Tmax. The seat 32 compresses the spring 43 in the shorter diameter direction and moves in the longitudinal direction X against the elastic force of the spring 43 when the barrel torque exceeds the predetermined torque Tmax. Resultingly, the seat 32 and the end stone 34 move in a direction away from the rotary barrel 11 and the third wheel 13. Accordingly, the mechanical timepiece movement provided with the spring seat 40 of Embodiment 2 can provide an operation and an effect similar to the mechanical timepiece movement 100 provided with the spring seat 30 of Embodiment 1.

### Third Embodiment

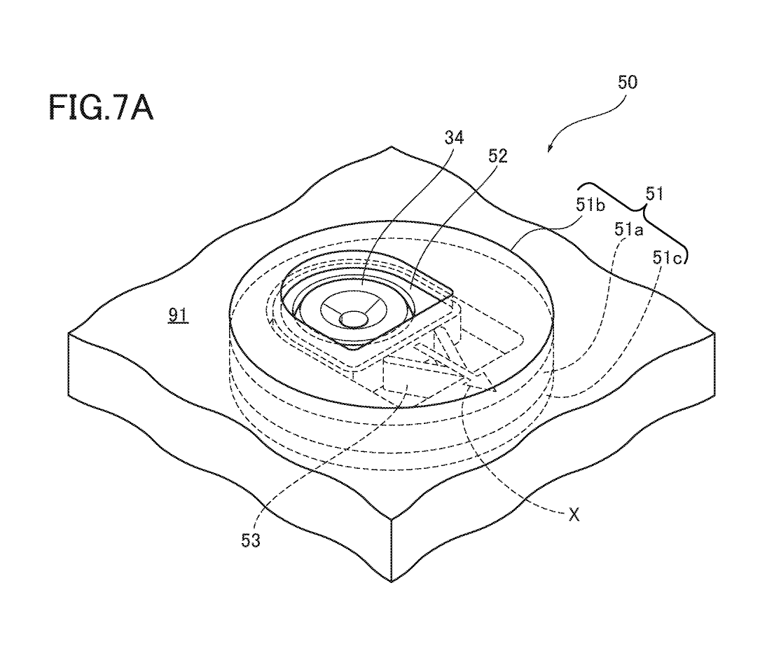

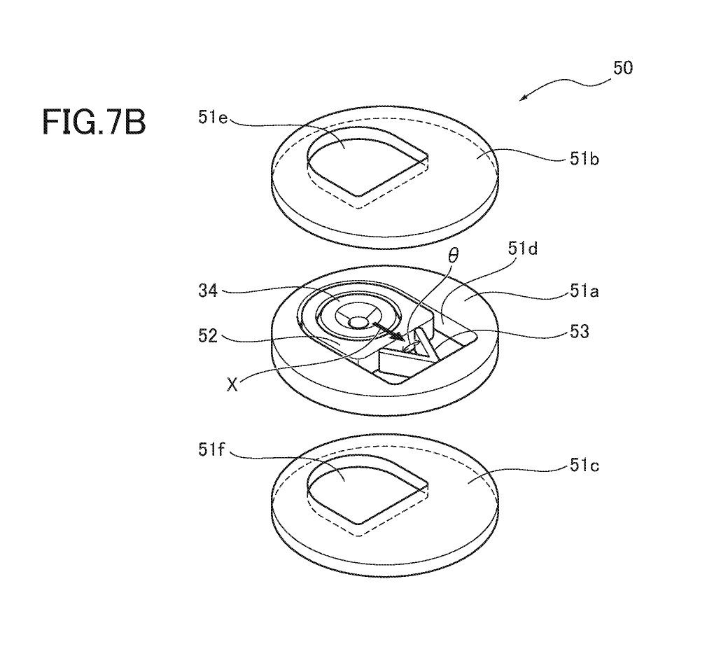

FIG. 7 is a perspective view of a spring-provided seat or spring seat 50 which is yet another example of the moving mechanism in the mechanical timepiece movement according to the third embodiment (Embodiment 3) of the present invention. The spring seat 50 is assembled and provided in the main plate 91. FIG. 7B is an exploded perspective view of the spring seat shown in FIG. 7A. The spring seat 50 differs from the spring seat 30 shown in FIGS. 2A, 2B and the spring seat 40 shown in FIG. 6. The spring seat 50 includes a guide 51a having an elongate hole 51d extending in a longitudinal direction X, a seat 52 housed within the elongate hole 51d and receiving the end stone 34, and a spring 53 biasing the seat 52, each of which is formed as an independent element.

It is necessary to prevent the seat 52 and the spring 53 from being separated from the guide 51a since the seat 52 and the spring 53 are independent from the guide 51a. Considering the above, in the spring seat 50, the guide 51a is laminated with covers 51b, 51c disposed on the top and bottom thereof as shown in FIGS. 7A and 7B. Each of the covers 51b, 51c has a hole 51e, 51f which is smaller than the contour of the seat 52. Note that the cover 51b, which is illustrated as the upper cover, may not necessarily has the hole 51e.

The hole 51e of the cover 51b is formed such that the pivot 12c (see FIGS. 3A and 3B) supported by the end stone 34 does not interfere with the cover 51b as the seat 52 moves within a space of the elongate hole 51d in the longitudinal direction X. The spring 53 is a leaf spring made of an elastic member such as metal. The spring 53 generates elastic force to return the included angle θ of the leaf spring to the original angle as the included angle θ increases. The elastic force acts as biasing force which biases the seat 52 toward one of the ends.

In the spring seat 50 of Embodiment 3 as configured above, a state in which the spring 53 biases the seat 52 is maintained and remains as shown in FIG. 7A while the barrel torque does not exceed the predetermined torque Tmax. The seat 52 moves in the longitudinal direction X against the elastic force of the spring 53 when the barrel torque exceeds the predetermined torque Tmax. Resultingly, the seat 52 and the end stone 34 move in a direction away from the rotary barrel 11 and the third wheel 13. Accordingly, the mechanical timepiece movement provided with the spring seat 50 of Embodiment 3 can provide an operation and an effect similar to the mechanical timepiece movement 100 provided with the spring seat 30 of Embodiment 1 or the spring seat 40 of Embodiment 2.

Note that in the Embodiments 1 and 2, the guide may be laminated with the covers 51b, 51c disposed on the top and bottom of the guide as the spring seat 50 of Embodiment 3 if the spring seats 30, 40 of Embodiment 1, 2 are configured such that the seat 32 and the spring 33, 34 are formed separate from the guide 31.

### CROSS-REFERENCE TO RELATED APPLICATION

The present application is based on and claims priority from Japanese Patent Application No. 2015-000127, filed on Jan. 5, 2015, the disclosure of which is hereby incorporated by reference in its entirety.

1. A mechanical timepiece movement comprising:
a power source that generates torque;
a governor;
a gear train mechanism that transmits the torque generated by the power source to the governor, the gear train mechanism including a plurality of gears engaging with each other; and
a moving mechanism that moves at least one of the gears of the gear train mechanism in a direction to reduce the transmission efficiency of the torque between the gears of the gear train mechanism when the torque generated by the power source is higher than a predetermined torque;
wherein the moving mechanism moves the gear moved by the moving mechanism in a direction away from other gears that engage with the gear moved by the moving mechanism; and
wherein the moving mechanism moves two end stones in the same direction that support a pivot of the gear moved by the moving mechanism on upper and lower sides of the pivot, respectively.

2. The mechanical timepiece movement according to claim 1, wherein the moving mechanism comprises:
an elongate hole that movably houses the end stones along a longitudinal direction, the end stones supporting a pivot of the gear moved by the moving mechanism, and the longitudinal direction being a direction that changes a distance from the other gears that engage with the gear moved by the moving mechanism; and
a biasing member that biases the end stones toward a side close to the other gears in the longitudinal direction when the torque generated by the power source does not exceed the predetermined torque and that moves the end stones away from the other gears when the torque generated by the power source exceeds the predetermined torque.

3. The mechanical timepiece movement according to claim 2, wherein the elongate hole of the moving mechanism is formed such that the longitudinal direction extends along a direction obtained from a vector addition of a load in accordance with the torque transmitted from a driving gear of the gears that engage with the gear moved by the moving mechanism and reaction force from a driven gear of the gears that engage with the gear moved by the moving mechanism.

4. The mechanical timepiece movement according to claim 2, wherein the moving mechanism comprises a base member provided with the elongate hole and fixed to at least one of a main plate and a gear train bridge of the movement, and the end stones disposed within a space of the elongate hole is integrally formed with the biasing member and the base member.

5. The mechanical timepiece movement according to claim 3, wherein the moving mechanism comprises a base member provided with the elongate hole and fixed to at least one of a main plate and a gear train bridge of the movement, and the end stones disposed within a space of the elongate hole is integrally formed with the biasing member and the base member.

6. (canceled)
